(19) United States
(12) Patent Application Publication
(10) Pub. No.: US 2009/0201145 A1
(43) Pub. Date: Aug. 13, 2009

(54) Safety socket

(76) Inventors: Hector Mario Vasquez, Traverse City, MI (US); Martin Kuttner, Holly Springs, NC (US)

Correspondence Address: The Weintraub Group, P.L.C., Suite 140, 28580 Orchard Lake Road, Farmington Hills, MI, 48334, US

(21) Appl. No.: 12/322,733

(22) Filed: Feb. 6, 2009

Related U.S. Application Data
(60) Provisional application No. 61/063,951, filed on Feb. 6, 2008.

(51) Int. Cl. G08B 1/08; G08B 21/00; H04B 1/38; H01R 25/00

(52) U.S. Cl. 340/539.1; 340/540; 455/90.1; 439/650

(57) ABSTRACT

Disclosed herein is a receptacle for selectively conducting electric power. The receptacle contains a switch that is normally open to prevent the occurrence of electric shock. An optical prong detector is provided to determine whether both the hot and neutral prongs of a plug have been inserted into the receptacle. The receptacle provides conductance upon determination of insertion of a plug into the receptacle. Additional features include GFI detection, current detection heat detection warning lights, and an audible alarm. The receptacle includes communication abilities with remote devices to transmit data indicative of the state of the device.

### CROSS-REFERENCE TO RELATED APPLICATION

This application claims the benefit of U.S. Provisional Application 61/063,951, which was filed on Feb. 6, 2008, the entire disclosure of which is hereby incorporated by reference.

### FIELD OF THE INVENTION

The present invention relates to a receptacle for preventing electrical shock. More specifically, the invention relates to a safety receptacle for distinguishing between a plug connected to the receptacle and another object.

### BACKGROUND OF THE INVENTION

Electrical receptacles, also known as sockets or outlets, as used in residential applications are commonly found mounted in an outlet box fixed within a wall and attached by terminals to an insulated powerline. The typical powerline used for residential purposes has a line that has three wires. The first conducts the AC power wave, which is commonly known as the “hot”; the second is a return line, which is commonly referred to as “neutral”; and the third is a solid copper conductor commonly referred to as “ground.”

The face of a typical receptacle has two parallel slots, and a third opening for the ground. Behind each of the slots and ground is a contact. A plug having two spades, or prongs, is inserted into a receptacle, thereby conducting power when it engages the contacts. When the receptacle is connected to the line and the circuit is energized, the contacts are live. A common concern in the art is electrical shock resulting from insertion of an object into one of the receptacle slots. The art is replete with solutions to the threat of potential electrocution associated with a child inserting a conductive object in the receptacle.

There are multiple solutions in the art consisting of covers and inserts to prevent electrical shock. However these devices may become damaged and worn from the constant insertion and removal. Such wear may also lead to neglecting their use altogether. In addition, small children may also pry off the covers to discover the mystery that lies beneath.

One such solution to this problem is the invention disclosed in U.S. Pat. No. 7,312,394, entitled “Protective device with tamper resistant shutters.” The '394 patent discloses a receptacle cover assembly having a shutter. The shutter is movable to an open position by the insertion of at least one plug blade having a predetermined geometry. Although the '394 patent offers a measure of protection by providing a physical barrier, it has no power shut-off safety feature, which would prove critical if an object other than a plug blade were able to deceive the device.

To prevent electrical shock in bathrooms, building codes require the use of ground fault interrupt “GFI” receptacles. In principle, these devices operate by measuring the current difference between the hot and neutral lines. If a threshold difference is reached a switch is opened and conduction to the contacts within the receptacle is terminated.

One such device is disclosed in U.S. Pat. No. 7,227,435 entitled “GFCI without bridge contacts and having means for automatically blocking a face opening of a protected receptacle when tripped.” The '435 patent discloses an invention which prevents insertion of the prongs of a plug when the GFI circuit is tripped in the event of mis-wiring or a switch failure. When the device is tripped, an arm moves downward causing the contact to open and a blocking member is moved to a blocking position. However, a concern with this system is in the event of a failure, the contact will not open, nor will the blocking member be moved into the blocking position.

One solution to the failing GFI switch is found in the invention disclosed in U.S. Pat. No. 7,317,600 entitled “Circuit interrupting device with automatic end of life test.” The '600 patent discloses a GFI circuit capable of simulating a ground fault to determine whether the device is working properly. An integrated circuit chip is connected to a switch that interacts with the reset button. A user can determine whether the device has failed by engaging the reset button. However, the user still needs to manually test the device to verify that it is working. Furthermore, the device is normally closed, making the contacts “hot” and hazardous.

Thus, it is desirable to provide a safety socket that can determine whether a plug has been engaged with the load side of the receptacle or if some other object had been placed into one of the slots. Additionally, it is also desirable to provide a receptacle that is normally open until a plug is engaged into the load side. Finally, it is also desirous to provide a receptacle that can communicate the device's state to external devices.

### SUMMARY OF THE INVENTION

A receptacle for selectively conducting electrical power comprises a housing having at least two apertures located on the load side of the receptacle and at least two conductor contacts, where each contact is disposed adjacent to each aperture to permit conduction with a user engageable contact, such as a blade of a plug. A contact detector having an emitter and a pair of detectors is disposed within the receptacle. Each detector emits a first signal to indicate the absence of an engageable contact and a second signal, distinguishable from the first signal, to indicate the presence of an engageable contact. An interrupter circuit having a line side, a load side and a switch is operatively coupled to a source of electrical power at the line side and to the conductor contacts on the load side. A switch is coupled between the line side and the load side to govern the flow of electrical power to the conductor contacts based on the signals from the receivers. The switch is either open or closed. A signal to cause the switch to conduct is received by the switch if the first and second receivers emit a signal indicative of the presence of an engageable contact.

In one embodiment, the receptacle has a switch that is normally open to prevent the flow of electrical power to the contacts. A microcontroller may be provided to receive signals from the detectors, the microcontroller having instructions to produce a third signal indicative of the presence of two or more engageable contacts in the receptacle and a fourth signal, distinguishable from the third signal, to indicate the presence of less than two engageable contacts in the receptacle. The microcontroller has instruction to transmit one of either a third or fourth signal to the interrupter circuit to cause the switch to open or close.

In one embodiment of the receptacle, the emitter produces light and the detectors produce a signal indicative of the light level detected. A filtering circuit may be coupled to the output of each detector, and the emitter being modulated to produce a target frequency to pass through the filter circuit, thereby eliminating ambient interference.

A partition is disposed between the emitter and each of the detectors, where the partition has an aperture to permit light from the emitter to reach the detectors while blocking ambient light.

In one embodiment, a plug is disposed on the line side of the receptacle, where the plug has at least two pins or prongs, where each of the pins is operatively coupled to one of said conductor contacts.

The receptacle may produce a unique tone signal to identify the receptacle from others. For example, the tone may identify the location of a fault or event, by knowing that a particular receptacle is in a bedroom, for example, the source of a current spike may be identified.

Additionally, the receptacle may comprise at least one communications conduit for transmitting signals indicative of the condition of the receptacle, the communications conduit selected from the group consisting of a power line, a serial port and a wireless port. Additional features include the addition of a thermal sensor, a current sensor,

a pyroelectric sensor, a warning light and an audible alarm.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is a front view of one embodiment of the receptacle according to the principles of the present invention, shown connected to a common electrical power line;

FIG. 2A is a perspective view of the receptacle of FIG. 1;

FIG. 2B is an alternate embodiment of the receptacle of FIG. 1, further comprising a plug with pins for mounting in a pre-existing receptacle;

FIG. 2C is a sectional view of the receptacle of FIG. 1, revealing an embodiment of a prong detector according to the principles of the present invention;

FIG. 2D is a diagram of one embodiment of a prong detector according to the principles of the present invention;

FIG. 3A is a schematic representation of a pair of prong detectors of FIG. 2D, revealing the operative elements therein;

FIG. 3B is a schematic representation of a pair of filters for filtering out ambient light from the detectors of FIG. 3A;

FIG. 4 is a schematic illustration of a microcontroller employed in one embodiment of the present invention, operatively coupled to a serial port;

FIG. 5A is a schematic illustration of an interrupter circuit according to the principles of the present invention, comprising a switch employing four silicon controlled rectifiers to open or close the AC power wave;

FIG. 5B is the interrupter circuit of FIG. 5A, further comprising a power transformer in front of the bridge diode of the power supply;

FIG. 6 is an illustration of a system of the present invention comprising a safety receptacle in communication with a master control panel;

FIG. 7 is an illustration of a master control panel according to the principles of the present invention.

### DESCRIPTION OF THE PREFERRED EMBODIMENT

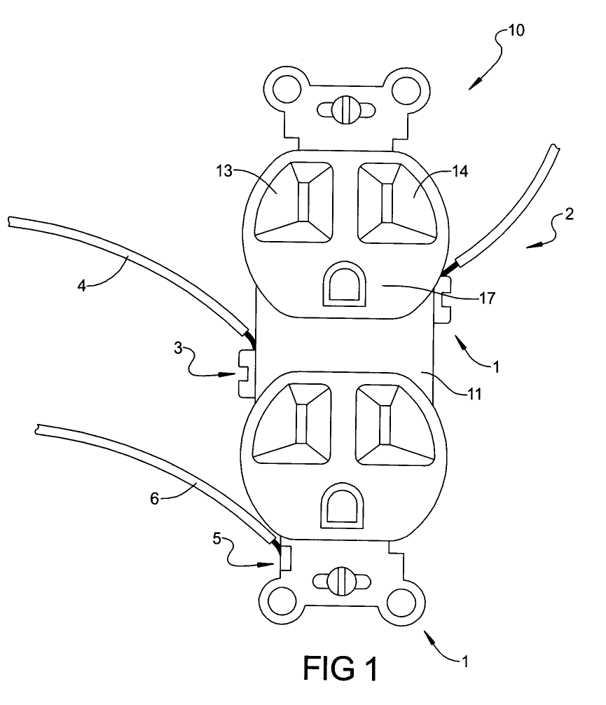

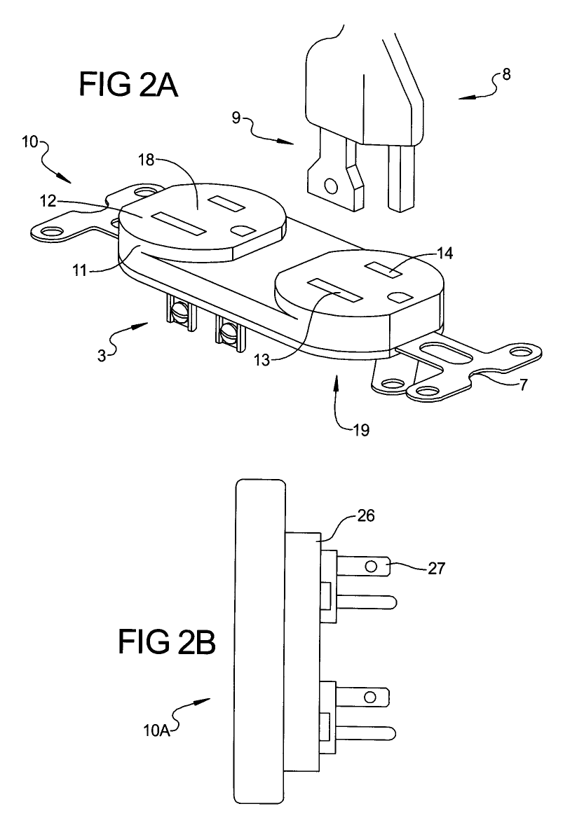

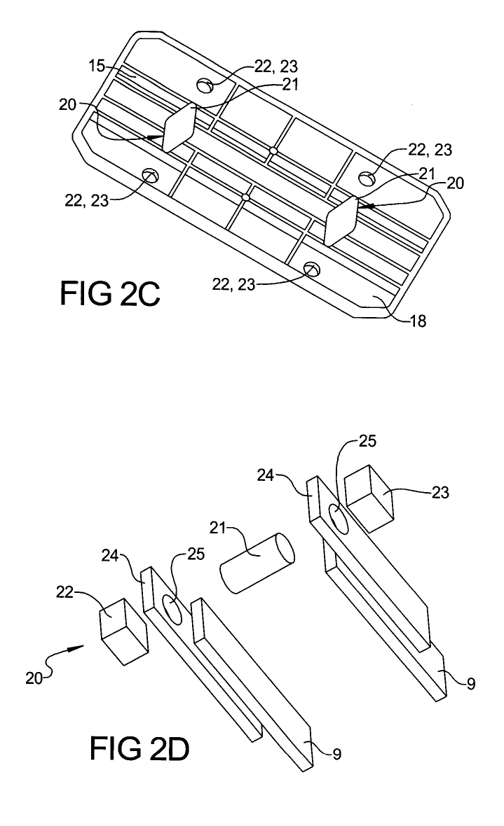

Referring now to FIG. 1 a front view of one embodiment of the receptacle 10 for selectively conducting electrical power comprises a housing 11 supported by a strap 7. Referring now also to FIG. 2A, the receptacle 10 has a load side 18 and a line side 19. A typical powerline connects at the line side 19 of the receptacle 10. The typical residential powerline has a conductor carrying the AC power wave, or hot wire 2, a return line, also known as the neutral wire 4, and a solid copper conductor that is tied to ground, referred to as the ground wire 6. The receptacle 10 is secured to the hot wire 2 at terminal 1, the neutral wire 4 at terminal 3 and the ground wire 6 is secured at terminal 5.

Referring now also to FIG. 2B, an alternate embodiment of the receptacle 10 of FIG. 1 is shown, further comprising a plug 26 with pins 27 extending therefrom for mounting the receptacle 10A of the present invention in a pre-existing receptacle, making the receptacle 10A portable and easy to install.

At least a neutral aperture 13 and a hot aperture 14 are located within the face 12 of the housing 11. For a grounded receptacle, a grounding aperture 17 is also present. A plug 8 having prongs 9, also known as pins or spades, couples to the receptacle 10 at the load side 18.

Referring now also to FIG. 2C, a sectional view of the receptacle 10 of FIG. 1 is shown. At least two conductor contacts 15, 16 are disposed within the receptacle 10. Each of the conductor contacts 15, 16 are disposed adjacent to each of the apertures 13, 14. Specifically, the neutral contact 15 is disposed adjacent to the neutral aperture 13 and hot contact 16 is disposed adjacent to the hot aperture 14 to permit conduction with a user engageable contact, such as the prong 9 of a plug 8, when inserted into one of the apertures 13, 14. For example, when the prongs 9 of plug 8 are inserted into apertures 13, 14, 17, the conductive material of the prongs 9 permit conduction with the hot and neutral contacts 15, 16.

Referring back to FIG. 2C, a prong detector 20 is disposed in the receptacle 10 and includes an emitter 21 and detectors 22, 23. Each of the detectors 22, 23 emitting a first signal to indicate the absence of an engageable contact in one of the apertures 13, 14 and a second signal, distinguishable from the first signal, to indicate the presence of an engageable contact in apertures 13, 14.

Referring now also to FIG. 2D, a diagram of one embodiment of a prong detector according to the principles of the present invention is shown, revealing the operative elements therein. In the preferred embodiment, the emitter 21 produces light and the detectors 22, 23 produce a signal indicative of the level of light detected. Partitions 24 are provided to minimize the interference of ambient light on the detectors 22, 23. The partitions 24 each have an aperture 25 disposed therein to permit light from the emitter 21 to reach the detectors 22, 23. Each of the prongs 9 when properly inserted will interfere with light from the emitter 21, causing a “no light” or “low light” signal from the detectors 22, 23. Therefore if both detector 22 and detector 23 indicate a low light signal, a plug is presumed to be coupled to receptacle 10. As such, when the emitter 21, detectors 22, 23 and partitions 24 with apertures 25 are positioned properly, the presence or absence of the user engageable contact such as prongs 9 may be detected.

Although residential applications have been referenced herein, those skilled in the art will immediately recognize that the application of the presence invention may be employed beyond residential and specifically may also employed in commercial and/or industrial applications. Additionally, even though light emitting and detecting methods are specifically disclosed herein, it is intended to be within the scope of the present invention that other means of detecting the presence of plug prongs be substituted for the light emitting and detecting methodologies disclosed herein.

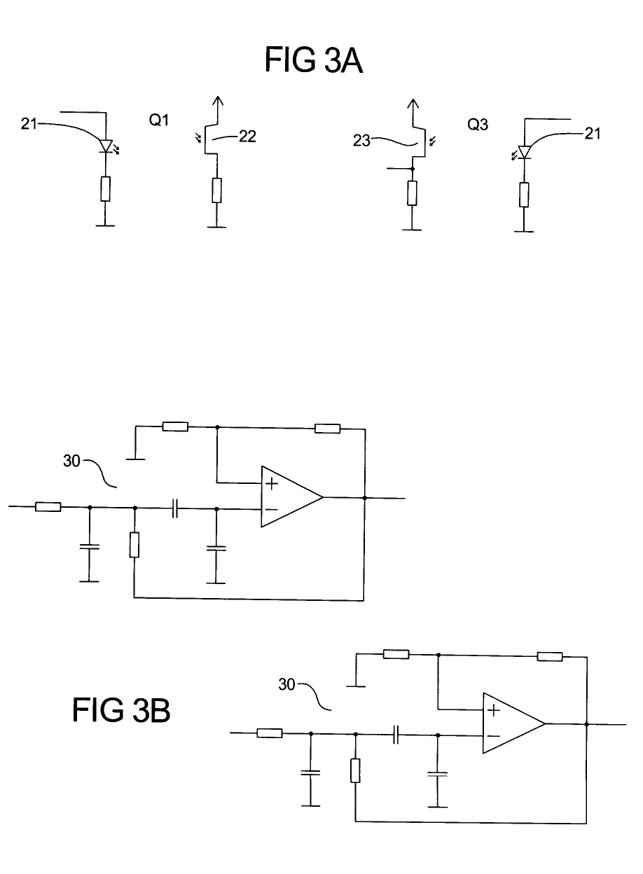

Referring now to FIG. 3A, a schematic representation of a pair of prong detectors of FIG. 2D, revealing the operative elements therein is shown. In the present embodiment, the emitter 21 is a light emitting diode, or “LED.” For example, it maybe of the type such as a GaAs infrared emitter. The detector 22 is an infrared phototransistor, which, as more light strikes the phototransistor, the higher the current flowing through the collector emitter leads. The circuits in FIG. 3A act like a voltage divider. The variable current through the resistor causes a voltage drop.

As a precautionary measure, in the preferred embodiment, the LED is modulated at about 100 kHz to produce a target frequency and then provided to a filtering circuit 30 as shown in FIG. 3B. A schematic representation of a pair of filters for filtering out ambient light from the detectors of FIG. 3A is shown. The signal that leaves the branch of FIG. 3A as 5NS_T1N enters the bandpass filtering circuit 30. The bandpass filter assists in eliminating erroneous signals that could be generated from ambient light by filtering the incoming voltage and therefore only signals energized by the LED which is modulated at about 100 kHz may pass. The output signal of the filtering circuit 30 T1N_D is then provided to a microcontroller identified as IC8.

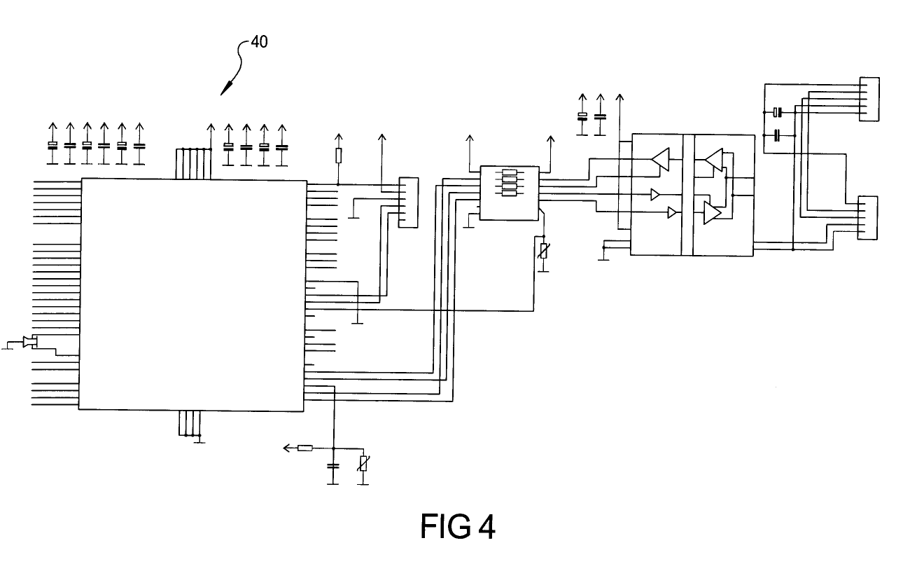

Referring now to FIG. 4, a schematic illustration of a microcontroller 40 employed in one embodiment of the receptacle 10 of the present invention is shown. The microcontroller 40 is a programmable logic device, and as such, any suitable programmable device may be substituted for the microcontroller 40 employed in the present invention. Microcontroller 40, also identified as IC8, receives signals produced by the detectors 22, 23. The microcontroller 40 has instructions to produce a third signal indicative of the presence of two or more engageable contacts 8 in the receptacle 10 and a fourth signal, distinguishable from the third signal, to indicate the presence of less than two engageable contacts in the receptacle 10. The microcontroller 40 transmits one of the third signal or fourth signal to an interrupter circuit to cause a switch to open or close. Additionally, microcontroller 40 receives signals from a number of other sensors, including a thermal sensor, current sensor, and a pyroelectric sensor. The output of microcontroller 40 is operatively coupled to number of communication devices located within the receptacle 10, including warning lights and audible alarms.

Microcontroller 40 also communicates through other communication conduits, for example, microcontroller 40 is shown coupled to a serial port, identified as IC9. Additionally microcontroller 40 may communicate through the powerline or wirelessly, for example, through the use of a transponder. The ability to communicate externally provides the receptacle 10 with the ability to transfer data about the state of the circuit for storage on location or off-site. This enables the device 10 to report faults in real-time or to demonstrate gradual deterioration of a condition, such as high current or heat, over time. Such information could be crucial in determining the cause of a fire, for example.

Microcontroller 40 is programmed to command the receptacle 10 to not conduct electricity unless the microcontroller 40 determines that a plug 8 is engaged with receptacle 10 and not merely some other object inserted into one of the apertures 13, 14. This is achieved by determining the presence of two blades 9 inserted into the apertures 13, 14 by the detectors 22, 23. Accordingly, the normal state of receptacle 10 is that no power is conducted to contacts 15, 16 unless a plug 8 is determined to be connected to the receptacle 10.

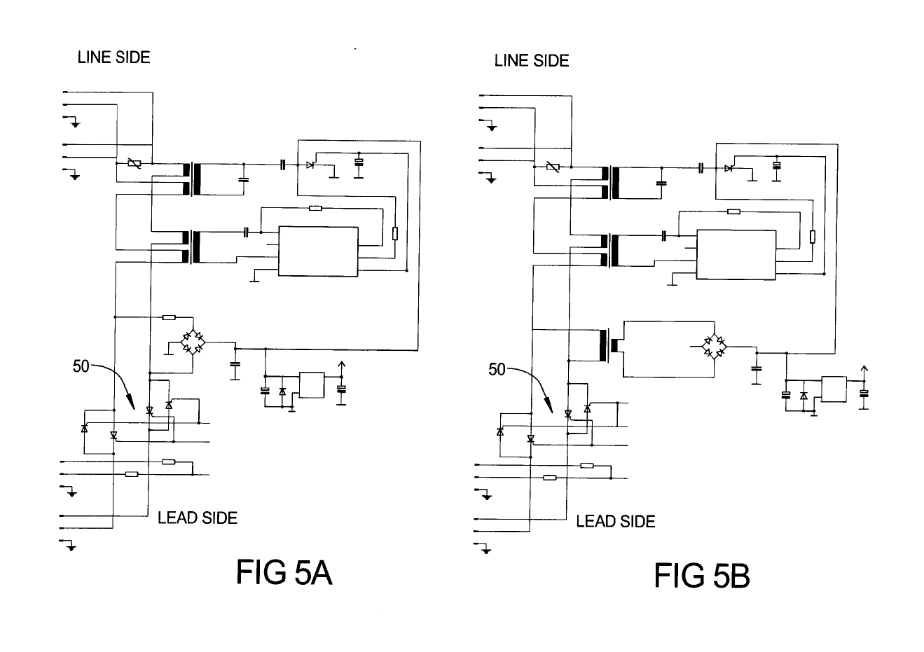

The output signals PH_A and PH_B from the microcontroller 40, based on signals from detectors 22, 23, govern the conductive state of the receptacle 10. Referring now also to FIG. 5A, a schematic illustration of an interrupter circuit 50 according to the principles of the present invention is shown. The interrupter circuit 50 has a line side, a load side and a switch. The line side is operatively coupled to a source of electrical power, for example a 14-2 wire. The load side is operatively coupled to the conductor contracts 15, 16. A switch is coupled between the line side and the load side to govern the flow of electrical power to the conductor contacts 15, 16 based on the signals from the detectors 22, 23.

The interrupter circuit 50 governs the flow of electrical power to the conductor contacts 15, 16 based on the signals received from the detectors 22, 23. The circuit 50 comprises a switch employing four silicon controlled rectifiers (SCR) T1-T4 to open or close the AC power wave. Each SCR is provided to conduct or not conduct a half wave coming into the receptacle 10 through terminal 1 or 3. Ideally only two SCRs should be necessary, however, in the event of mis-wiring the hot and neutral lines, two SCRs are provided on the neutral line as a safety precaution. The signals from PH_A and PH_B are provided to the gate of the SCRS. When PH_A and PH_B provide voltage sufficient to conduct across the SCRS, the interrupter circuit 50 is conductive. Note that T1 and T2 are in parallel, but flipped. This is because the SCRs only work in one direction. A diode bridge B2 is provided to rectify AC power to DC. Additionally, GFI protection is provided at TR6 and TR5. FIG. 5B is an alternate embodiment of the interrupter circuit of FIG. 5A, further comprising a power transformer TR3 in front of the bridge diode of the power supply.

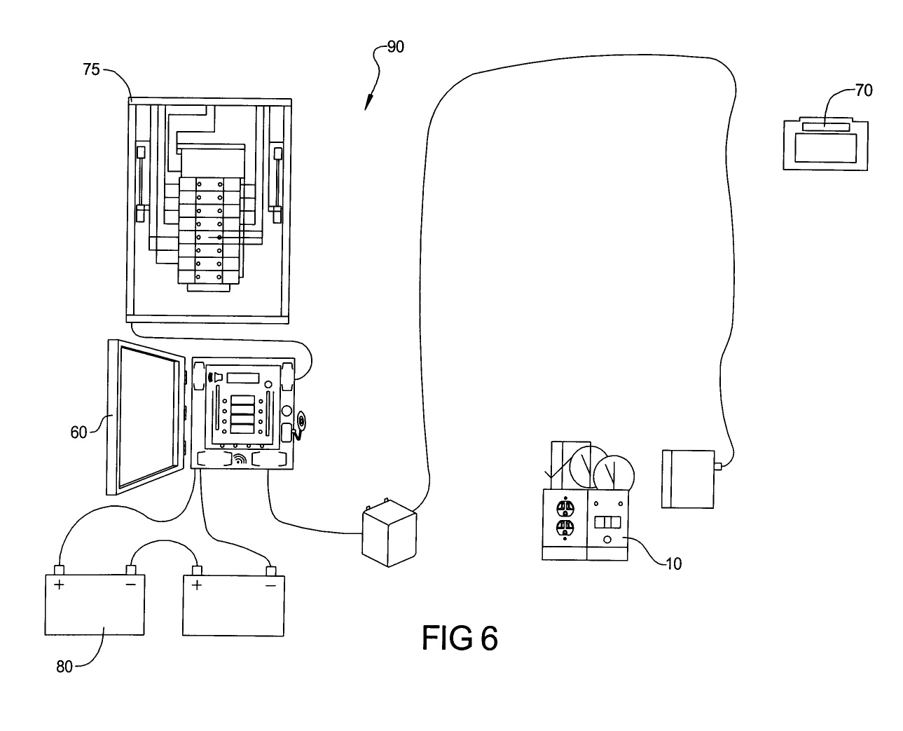

Referring now to FIG. 6, an illustration of a system 90 of the present invention comprising a safety receptacle 10 in communication with a master control panel 60 is shown. The control panel 60 is wired in line with the branches of the breaker box 75 at an input side and the receptacle on the output side. A wireless alert unit 70 provides notification of remote device status from information received wirelessly. The alert unit 70 is adapted to receive information from receptacle 10, including location information based on the receptacle identifier tone. The alert unit 70 may send a wireless alert to a computer.

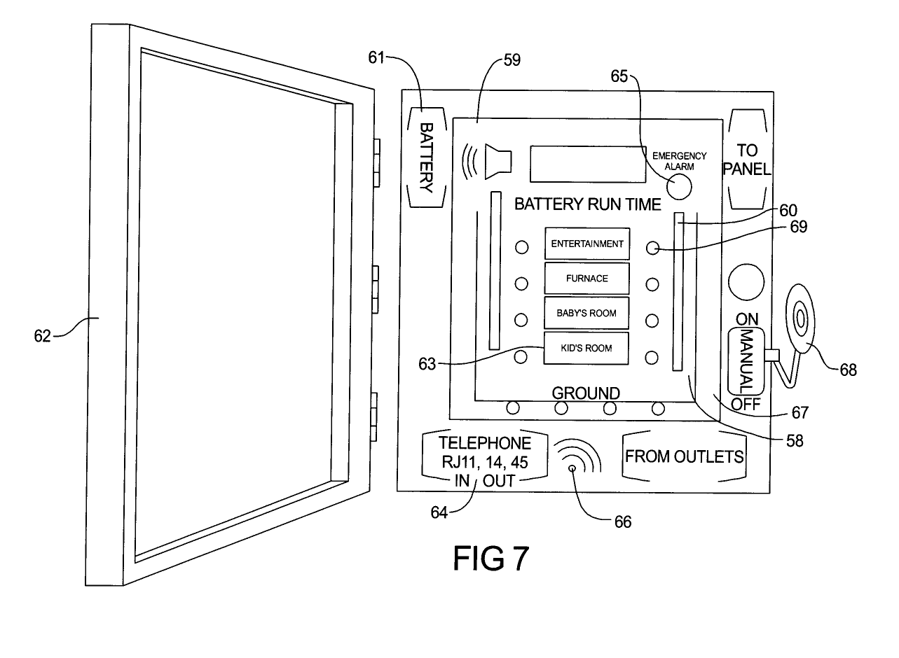

Referring now to FIG. 7, an illustration of a master control panel 60 according to the principles of the present invention is shown. The master control panel 60 comprises a case 62 containing electronic remote circuit breakers 63 for remotely disconnecting branch circuits. The control panel 60 includes a battery interface 61 for power backup or circuit conditioning. A beeper 59 and security alarm notification 65 provide warning in the event of a hazard. A transceiver 66 is provided for wireless communication with remote devices. Current sensors 67 are provided to measure branch currents which are reported on a display 58. A manual disconnect switch 68 is provided to terminate power to all downstream branches.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

1. An electrical receptacle for selectively conducting electrical power comprising:
a housing having a load side and a line side, the load side having at least two apertures disposed thereon for receiving a user engageable prong, the housing further having at least two conductor contacts, each of the conductor contacts being disposed adjacent to a respective aperture to permit conduction with the user engageable prong;
a contact detector for detecting the presence of a prong in each aperture, the contact detector having an emitter and a pair of detectors, the detectors producing a first signal indicative of the absence of a prong, and the detectors producing a second signal indicative of the presence of a prong; and
an interrupter circuit for governing the flow of electrical power to the conductor contacts, the interrupter circuit having a line side, a load side, and a switch, the switch operatively coupled to a source of electrical power at the line side, and operatively coupled to the conductor contacts at the load side, the switch configured to be closed when both detectors in the pair of detectors produces the second signal indicative of the presence of a prong.

2. The electrical receptacle of claim 1 wherein the receptacle comprises a microcontroller, the microcontroller being configured to receive signals from the detectors and transmit signals to the interrupter circuit, the microcontroller configured to transmit to the interrupter circuit a third signal when there is two or more prongs in the receptacle, and to transmit to the interrupter circuit a fourth signal when there is less than two prongs in the receptacle, and the switch being further configured to be closed when it receives the third signal from the microcontroller.

3. The electrical receptacle of claim 2 comprising a sensor and a communication device, the microcontroller being operatively coupled to the communication device and configured to receive a signal from the sensor.

4. The electrical receptacle of claim 1 wherein the emitter produces light and the first signal produced by the pair of detectors is indicative of the light level.

5. The electrical receptacle of claim 4 comprising a filtering circuit which is coupled to each detector, the emitter is further configured to produce a target frequency, and the filtering circuit is configured to eliminate erroneous signals generated from ambient light by filtering out signals not having the target frequency.

6. The electrical receptacle of claim 5 wherein the contact detector comprises a pair of partitions, each partition is disposed between the emitter and one of the respective detectors, the partition having an aperture to permit light to pass therethrough from the emitter to the respective detector whereby the partition blocks ambient light from the detector.

7. A system for monitoring and controlling an electrical receptacle comprising:
at least one electrical receptacle having a load side and a line side, the load side having at least two apertures disposed thereon for receiving a user engageable prong, the housing further having at least two conductor contacts, each of the conductor contacts being disposed adjacent to a respective aperture to permit conduction with the prong, and the receptacle configured to produce a unique tone; and
a master control panel, the master control panel having an input side wired in electrical connection with the branch circuits of a breaker box and an output side wired in electrical connection with the at least one electrical receptacle, at least one remote circuit breaker for disconnecting at least one of the electrical receptacles to its respective branch circuit.

8. The system of claim 7 wherein the master control panel comprises a battery interface configured to receive electrical power from a battery for power backup.

9. The system of claim 7 wherein the master control panel comprises an alarm system to provide notification in the event of a hazard.

10. The system of claim 7 wherein the master control panel comprises a transceiver for wireless communication with remote devices.

11. The system of claim 7 wherein the master control panel comprises a manual disconnect switch for terminating power to all of the electrical receptacles.

12. The system of claim 7 wherein at least one of the electrical receptacles comprises a current sensor which measures circuit branch electrical current, the current sensor being in communication with the master control, the master control having a display, and the master control configured to monitor the electrical current measured by each current sensor on the display.

13. The system of claim 12 wherein the master control comprises a wireless port and a wireless alert unit, the wireless port transmits signals indicative of the condition of at least one of the electrical receptacles, and the wireless alert unit receives the signals from the wireless port.

14. The system of claim 13 wherein the wireless alert unit sends a wireless alert signal to a computer.
